(19) United States
(12) Patent Application Publication
(10) Pub. No.: US 2026/0169582 A1
(43) Pub. Date: Jun. 18, 2026

(54) ELECTRONIC DEVICE AND METHOD FOR DRIVING THE SAME

(71) Applicant: Samsung Display Co., Ltd., Yongin-si (KR)

(72) Inventor: SEUNGROK LEE, Yongin-si (KR)

(21) Appl. No.: 19/292,757

(22) Filed: Aug. 6, 2025

(30) Foreign Application Priority Data
Dec. 13, 2024 (KR) 10-2024-0185425

(51) Int. Cl. G06F 3/041; G06F 3/044

(52) U.S. Cl. CPC G06F 3/0416; G06F 3/0446; G06F 2203/04111

(57) ABSTRACT

An electronic device includes: a sensor layer configured to sense an external input and including a plurality of sensing nodes; and a sensor driver configured to drive the sensor layer in a unit of a plurality of sensing frames, and to sense a coordinate, based on a capacitance measured at each of the plurality of sensing nodes, for each of the plurality of sensing frames, wherein the sensor driver includes: a coordinate determining unit configured to determine a first coordinate is maintained for a specific time; a sensitivity determining unit configured to determine a sum of the capacitances measured at the plurality of sensing nodes is gradually reduced, for at least two sensing frames of the plurality of sensing frames; and a coordinate setting unit configured to set the coordinate by comparing the sum of the capacitances with a touch limit value.

### CROSS-REFERENCE TO RELATED APPLICATION

The present application claims priority to and the benefit of Korean Patent Application No. 10-2024-0185425, filed on Dec. 13, 2024, in the Korean Intellectual Property Office, the entire disclosure of which is incorporated herein by reference.

### BACKGROUND

Aspects of some embodiments of the present disclosure described herein relate to an electronic device having relatively improved reliability and a method for driving the electronic device.

An electronic device includes a display layer to display images, a display driver configured to transmit a signal to the display layer, a sensor layer positioned on the display layer, and a sensor driver to transmit a driving signal to the sensor layer.

The sensor layer, which is a kind of an information input device, may be provided in the electronic device for use. For example, the sensor layer may be attached on one surface of the display layer, or may be formed integrally with the display layer, for use. The user may input information by pressing or touching the sensor layer while viewing an image display on a screen of the electronic device.

The above information disclosed in this Background section is only for enhancement of understanding of the background and therefore the information discussed in this Background section does not necessarily constitute prior art.

### SUMMARY

Aspects of some embodiments of the present disclosure include an electronic device having relatively improved sensing reliability and a method for driving the same.

According to some embodiments of the present disclosure, an electronic device may include a sensor layer sensing an external input and including a plurality of sensing nodes, and a sensor driver driving the sensor layer in a unit of a plurality of sensing frames, and sensing a coordinate, based on a capacitance at each of the plurality of sensing nodes for each of the plurality of sensing frames. According to some embodiments, the sensor driver may include a coordinate determining unit to determine whether a first coordinate is maintained for a specific time, a sensitivity determining unit to determine whether a sum of the capacitances at the plurality of sensing nodes is gradually reduced, for at least two sensing frames of the plurality of sensing frames, and a coordinate setting unit to set the coordinate by comparing the sum of the capacitances with a touch limit value.

According to some embodiments, the first coordinate may be calculated through Center of Mass, based on a first sensing node, which has the highest capacitance, of the plurality of sensing nodes, second sensing nodes spaced apart from each other in a first direction while interposing the first sensing node between the second sensing nodes, and third sensing nodes spaced apart from each other in a second direction crossing the first direction, while interposing the first sensing node between the third sensing nodes.

According to some embodiments, the sum of the capacitances may be a sum of capacitances which are measured at the first sensing node, the second sensing nodes, and the third sensing nodes, respectively.

According to some embodiments, each of the plurality of sensing nodes may include a first electrode extending in the first direction and a second electrode extending in the second direction.

According to some embodiments, the first electrode may include a plurality of first parts extending in the first direction and a plurality of second parts spaced apart from each other while interposing the plurality of first parts between the second parts. According to some embodiments, the plurality of first parts and the plurality of second parts may be in the same layer.

According to some embodiments, the second electrode may include a bridge pattern extending in the second direction and a plurality of sensing patterns connected to the bridge pattern and spaced apart from each other in the second direction, and the plurality of sensing patterns and the bridge pattern may be in different layers.

According to some embodiments, the coordinate setting unit may determine the external input as being removed, based on the sum of the capacitances being less than the touch limit value.

According to some embodiments, the coordinate setting unit may set the first coordinate as the coordinate, based on the sensitivity determining unit determining the sum of the capacitances as being gradually reduced, and based on the coordinate setting unit determining the external input as being removed.

According to some embodiments, the sensor driver may neglect a coordinate sensed for each of the at least two sensing frames.

According to some embodiments, the at least two sensing frames may be processed after the coordinate determining unit determines whether the first coordinate is maintained for a specific time.

According to some embodiments, the specific time may be one second.

According to some embodiments, the touch limit value may be ‘0’.

According to some embodiments of the present disclosure, a method for driving an electronic device, which includes a sensor layer sensing an external input and including a plurality of sensing nodes; and a sensor driver driving the sensor layer in a unit of a plurality of sensing frames, and sensing a coordinate, based on a capacitance at each of the plurality of sensing nodes, for each of the plurality of sensing frames, may include determining whether a first coordinate is maintained for a specific time, determining whether a sum of the capacitances at the plurality of sensing nodes is gradually reduced, for at least two sensing frames of the plurality of sensing frames, and setting the coordinate by comparing the sum of the capacitances with a touch limit value.

According to some embodiments, the method may further include calculating the first coordinate through Center of Mass, based on a first sensing node, which has the highest capacitance, of the plurality of sensing nodes, second sensing nodes spaced apart from each other in a first direction while interposing the first sensing node between the second sensing nodes, and third sensing nodes spaced apart from each other in a second direction crossing the first direction, while interposing the first sensing node between the third sensing nodes.

According to some embodiments, the sum of the capacitances may be a sum of capacitances which are measured at the first sensing node, the second sensing nodes, and the third sensing nodes, respectively.

According to some embodiments, the setting of the coordinate may include determining the external input as being removed, when the sum of the capacitances is less than the touch limit value.

According to some embodiments, the setting of the coordinate may include setting the first coordinate as the coordinate, based on the sensitivity determining unit determining the sum of the capacitances as being gradually reduced, and based on the coordinate determining unit determining the external input as being removed.

According to some embodiments, the setting of the coordinate may include neglecting a coordinate sensed for each of the at least two sensing frames.

According to some embodiments, the determining of the sum of the capacitances as being gradually reduced may be performed after determining whether the first coordinate is maintained for a specific time.

According to some embodiments, the specific time may be one second.

### BRIEF DESCRIPTION OF THE DRAWINGS

The above and other aspects and characteristics of embodiments according to the present disclosure will become more apparent by describing in more detail aspects of some embodiments thereof with reference to the accompanying drawings.

FIG. 1 is a block diagram of an electronic device according to some embodiments of the present disclosure.

FIG. 2 illustrates schematically an electronic device according to some embodiments.

FIG. 3 is a perspective view of an electronic device according to some embodiments of the present disclosure.

FIG. 4 is a block diagram schematically illustrating an electronic device and a user hand according to some embodiments of the present disclosure.

FIG. 5 is a cross-sectional view illustrating a display panel according to some embodiments of the present disclosure.

FIG. 6 is a cross-sectional view illustrating a display module taken along line I-I′ of FIG. 3 according to some embodiments of the present disclosure.

FIG. 7 is a block diagram of a display layer and a display driver according to some embodiments of the present disclosure.

FIG. 8 is a block diagram illustrating a sensor layer and a sensor driver according to some embodiments of the present disclosure.

FIG. 9 is a cross-sectional view taken along line II-II′ of FIG. 8 according to some embodiments of the present disclosure.

FIG. 10 is an enlarged plan view of a crossing region of FIG. 8 according to some embodiments of the present disclosure.

FIG. 11 is a block diagram illustrating a sensor control circuit according to some embodiments of the present disclosure.

FIG. 12 is a flowchart illustrating aspects of a method for driving an electronic device according to some embodiments of the present disclosure.

FIG. 13 is a view to describe the driving of a sensor driver according to some embodiments of the present disclosure.

FIG. 14 is a view to describe a sensor layer and a sensor driver according to some embodiments of the present disclosure.

FIG. 15 is a view illustrating an active region of an electronic device according to some embodiments of the present disclosure.

FIG. 16 illustrates sensing nodes of region AA of FIG. 15 according to some embodiments of the present disclosure.

FIGS. 17A to 17E are views illustrating sensing nodes and a plurality of sensitivity values in region AA of FIG. 15 according to some embodiments of the present disclosure.

### DETAILED DESCRIPTION

In the specification, the expression that a first component (or region, layer, or part) is “on”, “connected to”, or “coupled to” a second component refers to that the first component is directly on, connected to, or coupled to the second component or refers to that a third component is interposed therebetween.

The same reference numeral will be assigned to the same component. In addition, in drawings, thicknesses, proportions, and dimensions of components may be exaggerated to describe the technical features effectively. The term “and/or” includes any and all combinations of one or more of associated components

Although the terms “first”, or “second” may be used to describe various components, the components should not be construed as being limited by the terms. The terms are only used to distinguish one element, component, region, layer, or part from another element, component, region, layer, or part. For example, without departing from the scope and spirit of the present disclosure, a first element, a first component, a first region, a first layer, or a first part may be referred to as a second element, a second component, a second region, a second layer, or a second part, and similarly, the second element, the second component, the second region, the second layer, or the second part may be referred to as the first element, the first component, the first region, the first layer, or the first part. The singular forms are intended to include the plural forms unless the context clearly indicates otherwise.

In addition, the terms “under”, “at a lower portion”, “above”, “an upper portion” are used to describe the relationship between components illustrated in drawings. The terms are relative and will be described with reference to a direction indicated in the drawing.

It will be further understood that the terms “comprise,” “include,” or “including,” or “have” or “having” specify the presence of stated features, numbers, steps, operations, components, parts, or the combination thereof, but do not preclude the presence or addition of one or more other features, numbers, steps, operations, components, components, and/or the combination thereof.

Unless defined otherwise, all terms (including technical terms and scientific terms) used in the specification have the same meaning as commonly understood by one skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to drawings.

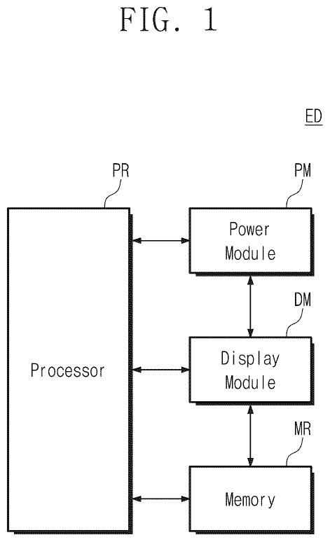

FIG. 1 is a block diagram of an electronic device according to some embodiments of the present disclosure.

An electronic device according to the present disclosure may be provided in various forms. The electronic device according to the present disclosure may further include a module or a device having various additional functions.

Referring to FIG. 1, an electronic device ED according to some embodiments may include a display module DM, a processor PR, a memory MR, and a power module PM.

The processor PR may include at least one of a central processing unit (CPU), an application processor (AP), a graphic processing unit (GPU), a communication processor (CP), an image signal processor (ISP), or a controller. The processor PR may control the power module PM, the display module DM, and the memory MR.

The memory MR may store data information necessary for the operation of the processor PR or the display module DM. When the processor PR runs the application stored in the memory MR, an image data signal and/or an input control signal may be transmitted to the display module DM, and the display module DM may process the transmitted signal and output the image information through the display screen.

The power module PM may include a power supply module, such as a power adaptor or a battery device, and a power converting module to convert the power supplied from the power supply module into power necessary for the operation of the electronic device ED.

The display module DM may operate in response to an electrical signal. Some among individual modules functionally included in one module may be included in the display module DM, and other modules among the individual modules may be provided in the electronic device ED, separately from the display module DM.

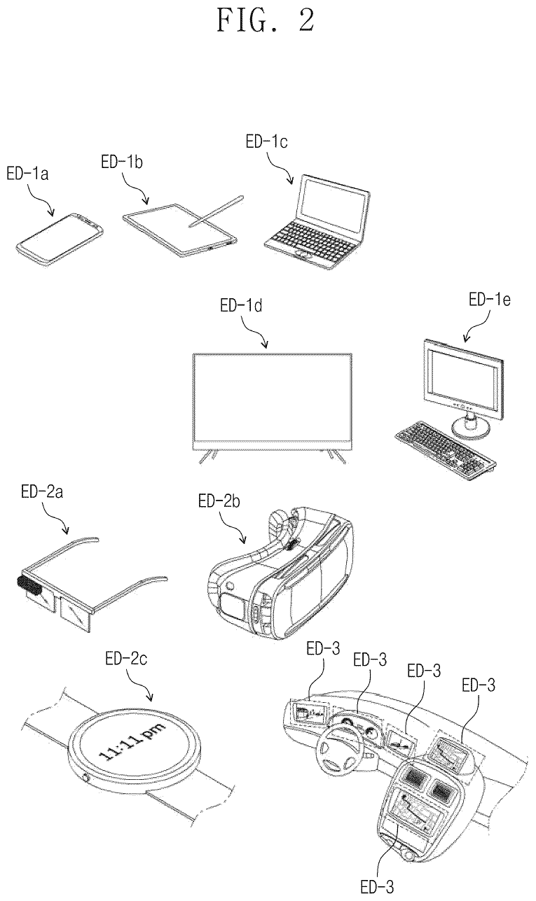

FIG. 2 illustrates schematic views of an electronic device according to some embodiments of the present disclosure.

Referring to FIG. 2, an electronic device according to various embodiments may be a wearable electronic device including a display module such as smart glasses ED_2a, a head mounted display ED_2b, and a smart watch ED_2c, as well as an electronic device for image display such as a smartphone ED_1a, a tablet PC ED_1b, a laptop computer ED_1c, a television (TV) ED_1d, and a desk monitor ED_1e.

In addition, the electronic device according to various embodiments is applied to an interior of a transfer device, such as a vehicle, to provide, for a user, various pieces of information through an image. For example, a storage device according to the present disclosure may be provided in the form of an electronic device ED-3 for the vehicle including the display module such as a center information display (CID), which is located in a dashboard, or a room mirror display.

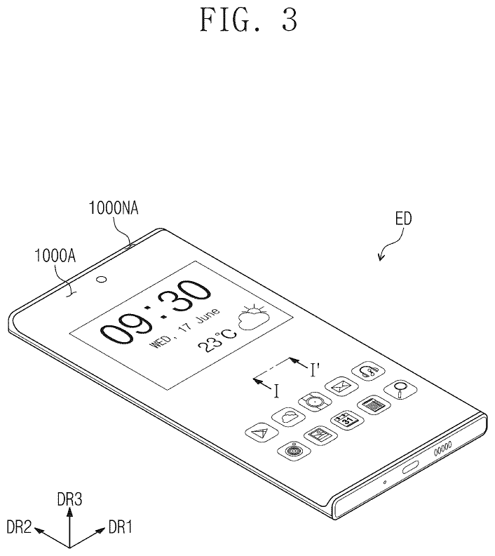

FIG. 3 is a perspective view of an electronic device according to some embodiments of the present disclosure.

Referring to FIG. 3, the electronic device ED may be a device that is activated in response to an electrical signal. For example, the electronic device ED may be a cellular phone, a foldable phone, a laptop computer, a television, a tablet, a vehicle navigation system, a game console, or a wearable device, but embodiments according to the present disclosure are not limited thereto. FIG. 1 illustrates that the electronic device ED is a cellular phone.

The electronic device ED may include an active region 1000A and a peripheral region 1000NA defined in the electronic device 1000. The electronic device ED may display an image through the active region 1000A. The active region 1000A may include a surface defined by a first direction DR1 and a second direction DR2. The peripheral region 1000NA may surround (e.g., in a periphery or outside a footprint of) the active region 1000A.

A thickness direction of the electronic device ED may be parallel to a third direction DR3 crossing the first direction DR1 and the second direction DR2. Accordingly, a front surface (or top surface) and a rear surface (or bottom surface) of members constituting the electronic device ED may be defined based on the third direction DR3.

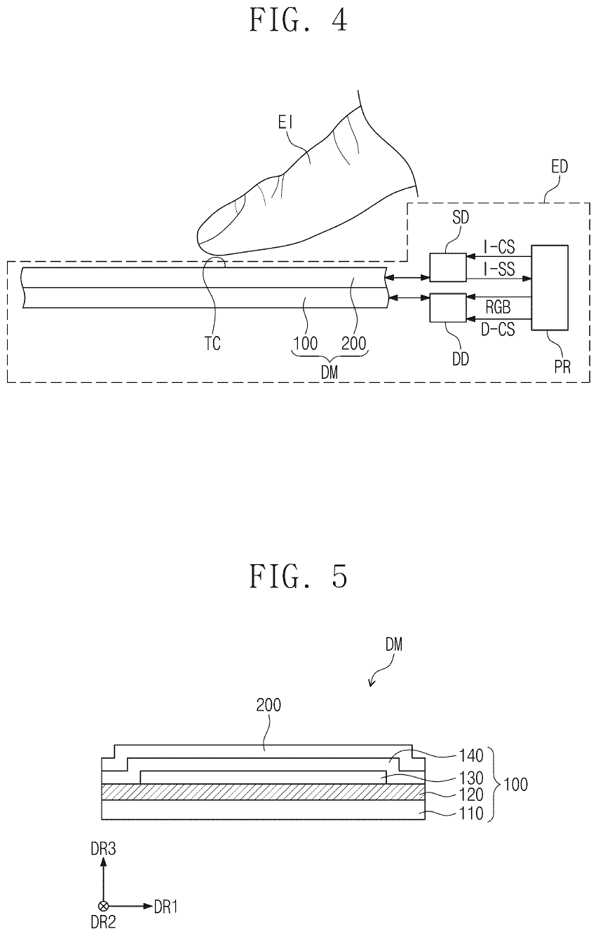

FIG. 4 is a block diagram schematically illustrating an electronic device and a user hand according to some embodiments of the present disclosure.

Referring to FIG. 4, the electronic device ED may include the display module DM, a display driver DD, a sensor driver SD, and the processor PR.

The display module DM may include a display layer 100 and a sensor layer 200.

The display layer 100 may be a component which generates an image. The display layer 100 may be an emissive-type display layer. For example, the display layer 100 may be an organic light emitting display layer, a quantum dot display layer, a micro-LED display layer, or a nano-LED display layer.

The sensor layer 200 may be located on the display layer 100. The sensor layer 200 may sense an external input applied thereto from an outside. The sensor layer 200 may sense a touch input TC made by a hand EI of a user which is the external input.

The processor PR may control an overall operation of the electronic device ED. For example, the processor PR may control operations of the display driver DD and the sensor driver SD. The processor PR may include at least one microprocessor, and the processor PR may be referred to as a “host”.

The display driver DD may control the display layer 100. The processor PR may further include a graphics controller. The display driver DD may receive image data RGB and a control signal D-CS from the processor PR. The control signal D-CS may include various signals. For example, the control signal D-CS may include an input vertical synchronization signal, an input horizontal synchronization signal, a main clock, or a data enable signal. The display driver DD may generate a vertical synchronization signal and a horizontal synchronization signal for controlling the timing to provide a signal to the display layer 100, based on the control signal D-CS.

The sensor driver SD may drive the sensor layer 200. The sensor driver SD may receive a control signal I-CS from the processor PR. The control signal I-CS may include a mode setting signal for setting a driving mode of the sensor driver SD, and a clock signal. The sensor driver SD may operate in a mode for sensing the touch input TC, which is made by the hand El of the user, based on the control signal I-CS.

The sensor driver SD may calculate information about a coordinate of the touch input TC, based on the signal received from the sensor layer 200, and may provide, to the processor PR, the coordinate signal I-SS having the information about a coordinate.

The sensor driver SD and the processor PR may be connected to each other through Intern Integral circuit (12C) communication or Serial peripheral interface (SPI) communication.

The processor PR may perform an operation corresponding to the user input based on the coordinate signal I-SS. For example, the processor PR may operate the display driver DD based on the coordinate signal I-SS such that a new application image is displayed on the display layer 100.

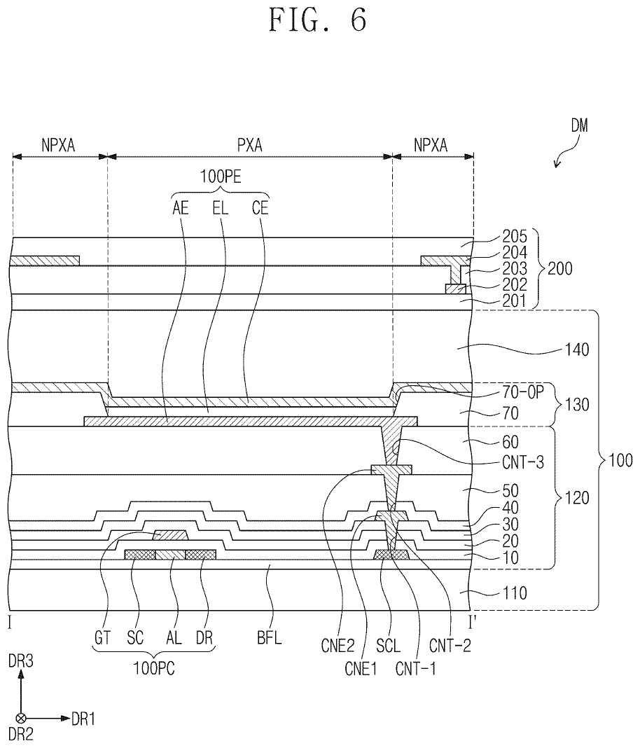

FIG. 5 is a block diagram of an electronic device according to some embodiments of the present disclosure.

Referring to FIG. 5, the display module DM may include the display layer 100 and the sensor layer 200.

The display layer 100 may include a base layer 110, a circuit layer 120, a light emitting element layer 130, and an encapsulating layer 140.

The base layer 110 may be a member which provides a base surface for disposing the circuit layer 120. The base layer 110 may be a glass substrate, a metal substrate, a polymer substrate, or the like. However, embodiments according to the present disclosure are not limited thereto, and the base layer 110 may be an inorganic layer, an organic layer, or a composite material layer.

The circuit layer 120 may be located on the base layer 110. The circuit layer 120 may include an insulating layer, a semiconductor pattern, a conductive pattern, or a signal line. An insulating layer, a semiconductor layer, and a conductive layer may be formed on the base layer 110 through a coating or deposition process, and then may be selectively patterned through a plurality of photolithography processes. Thereafter, the semiconductor pattern, the conductive pattern, and the signal line, which are included in the circuit layer 120, may be formed.

The light emitting element layer 130 may be located on the circuit layer 120. The light emitting element layer 130 may include a light emitting element. For example, the light emitting element layer 130 may include an organic light emitting material, an inorganic light emitting material, an organic-inorganic light emitting material, a quantum dot, a quantum rod, a micro-LED, or a nano-LED.

The encapsulating layer 140 may be located on the light emitting element layer 130. The encapsulating layer 140 may protect the light emitting element layer 130 from foreign substances or contaminants such as moisture, oxygen, and dust particles.

The sensor layer 200 may be located on the display layer 100. The sensor layer 200 may sense an external input applied thereto from an outside. The external input may be an input of the user. The user input may include various types of external inputs such as a part of a user body, light, heat, a pen, or pressure.

The sensor layer 200 may be formed on the display layer 100 through a subsequent process. In this case, the sensor layer 200 may be expressed as being directly located on the display layer 100. The wording “˜being directly located˜” may indicate that a third component is not intervened between the sensor layer 200 and the display layer 100. In other words, an additionally adhesive member may not be interposed between the sensor layer 200 and the display layer 100. Alternatively, the sensor layer 200 may be bonded to the display layer 100 through an adhesive member. The adhesive member may include a typical adhesive or sticking agent.

According to some embodiments, the display module DM may further include an anti-reflective layer and an optical layer on the sensor layer 200. The anti-reflective layer may relatively reduce reflectance of external light incident from the outside of the display module DM. The optical layer may relatively improve the front brightness of the display module DM by controlling a direction of a light incident from the display layer 100.

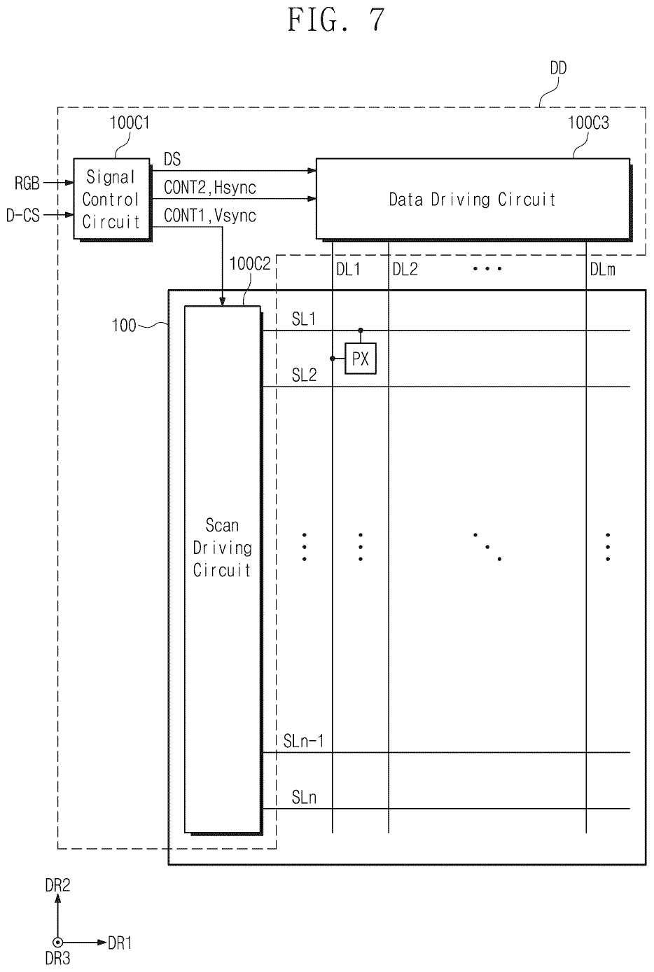

FIG. 6 is a cross-sectional view of a display module taken along line I-I′ of FIG. 3 according to some embodiments of the present disclosure.

Referring to FIG. 6, at least one inorganic layer may be formed on a top surface of the base layer 110. The inorganic layer may include at least one of an aluminum oxide, a titanium oxide, a silicon oxide, a silicon nitride, a silicon oxynitride, a zirconium oxide, or hafnium oxide. The inorganic layer may have a multiple-layer structure. The multiple inorganic layers may constitute a barrier layer and/or a buffer layer. According to some embodiments, the display layer 100 is illustrated as including a buffer layer BFL.

The buffer layer BFL may relatively improve a bonding force between the base layer 110 and the semiconductor pattern. The buffer layer BFL may include at least one of a silicon oxide, a silicon nitride, or a silicon oxynitride. For example, the buffer layer BFL may include a structure in which a silicon oxide layer and a silicon nitride layer are stacked alternately.

The semiconductor pattern may be located on the buffer layer BFL. For example, the semiconductor pattern may include polysilicon. However, embodiments according to the present disclosure are not limited thereto, and the semiconductor pattern may include amorphous silicon, low-temperature polycrystalline silicon, or oxide semiconductor.

FIG. 6 illustrates merely a portion of the semiconductor pattern, and the semiconductor pattern may be further located in another region. The semiconductor patterns may be arranged across pixels in compliance with a specific rule. The semiconductor pattern may have various electrical properties depending on a doping state. The semiconductor pattern may include a first having higher conductivity and a second region having lower conductivity. The first region may be doped with an N-type dopant or a P-type dopant. A P-type transistor may include a doping region doped with the P-type dopant, and an N-type transistor may include a doping region doped with the N-type dopant. The second region may be a non-doping region or a region doped at a concentration lower than a concentration of the first region.

The conductivity of the first region may be greater than the conductivity of the second region and may serve as an electrode or a signal line. The second region may correspond to an active region (or a channel) of a transistor. In other words, a portion of the semiconductor pattern may be the active region of the transistor, another portion of the semiconductor pattern may be a source region or a drain region of the transistor, and another portion of the semiconductor pattern may be a connection electrode or a connection signal line.

Each of pixels may have an equivalent circuit including seven transistors, one capacitor, and one light emitting element, and the equivalent circuit of the pixel may be modified in various forms. FIG. 6 illustrates that the pixel includes one transistor 100PC and one light emitting element 100PE, which are included in the pixel.

The source region SC, the active region AL, and the drain region DR of the transistor 100PC may be formed from the semiconductor pattern. The source region SC and the drain region DR may extend in directions facing away from each other from the active region AL when viewed in a cross-sectional view. A portion of the connection signal line SCL formed from the semiconductor pattern is illustrated in FIG. 6. Although not separately illustrated, the connection signal line SCL may be connected to the drain region DR of the transistor 100PC when viewed in a plan view.

A first insulating layer 10 may be located on the buffer layer BFL. The first insulating layer 10 may be overlapped with a plurality of pixels in common to cover the semiconductor pattern. The first insulating layer 10 may be an inorganic layer and/or an organic layer and may have a single-layer structure or a multi-layer structure. The first insulating layer 10 may include at least one of an aluminum oxide, a titanium oxide, a silicon oxide, a silicon nitride, a silicon oxynitride, a zirconium oxide, or hafnium oxide. According to some embodiments, the first insulating layer 10 may be a silicon oxide layer in a single-layer structure. An insulating layer of the circuit layer 120, which is to be described below, as well as the first insulating layer 10, may be an inorganic layer and/or an organic layer, and may have a single-layer structure or a multi-layer structure. The inorganic layer may include at least one of the above-described materials, but embodiments according to the present disclosure are not limited thereto.

A gate GT of the transistor 100PC is located on the first insulating layer 10. The gate GT may be a portion of a metal pattern. The gate GT is overlapped with the active region AL. The gate GT may function as a mask in the process of doping the semiconductor pattern.

A second insulating layer 20 may be located on the first insulating layer 10 to cover the gate GT. The second insulating layer 20 may be overlapped with the pixels in common. The second insulating layer 20 may be an inorganic layer and/or an organic layer and may have a single-layer structure or multi-layer structure. The second insulating layer 20 may include at least one of silicon oxide, silicon nitride, or silicon oxynitride. According to some embodiments, the second insulating layer 20 may have a multi-layer structure including a silicon oxide layer and a silicon nitride layer.

A third insulating layer 30 may be located on the second insulating layer 20. The third insulating layer 30 may have a single-layer or multi-layer structure. For example, the third insulating layer 30 may have a multi-layer structure including a silicon oxide layer and a silicon nitride layer.

A first connection electrode CNE1 may be located on the third insulating layer 30. The first connection electrode CNE1 may be connected with the connection signal line SCL through a contact hole CNT-1 formed through the first, second, and third insulating layers 10, 20, and 30.

A fourth insulating layer 40 may be located on the third insulating layer 30. The fourth insulating layer 40 may be a silicon oxide layer in a single layer. A fifth insulating layer 50 may be located on the fourth insulating layer 40. The fifth insulating layer 50 may be an organic layer.

A second connection electrode CNE2 may be located on the fifth insulating layer 50. The second connection electrode CNE2 may be connected to the first connection electrode CNE1 through a contact hole CNT-2 formed through the fourth insulating layer 40, and the fifth insulating layer 50.

A sixth insulating layer 60 may be located on the fifth insulating layer 50 to cover the second connection electrode CNE2. The sixth insulating layer 60 may be an organic layer.

A light emitting element layer 130 may be located on the circuit layer 120. The light emitting element layer 130 may include the light emitting element 100PE. For example, the light emitting element layer 130 may include an organic light emitting material, an inorganic light emitting material, an organic-inorganic light emitting material, a quantum dot, a quantum rod, a micro-LED, or a nano-LED. The following description will be described while focusing on that the light emitting element 100PE is an organic light emitting element, but embodiments according to the present disclosure are not specifically limited thereto.

The light emitting element 100PE may include a first electrode AE, a light emitting layer EL, and a second electrode CE.

The first electrode AE may be located on the sixth insulating layer 60. The first electrode AE may be connected to the second connection electrode CNE2 through a contact hole CNT-3 formed through the sixth insulating layer 60.

A pixel defining layer 70 may be located on the sixth insulating layer 60 to cover a portion of the first electrode AE. An opening 70-OP is defined in the pixel defining layer 70. The opening 70-OP of the pixel defining layer 70 exposes at least a portion of the first electrode AE.

The active region 1000A (see FIG. 1A) may include an emission region PXA and a non-emission region NPXA adjacent to the emission region PXA. The non-emission region NPXA may surround the light emitting region PXA. According to some embodiments, the emission region PXA is defined to correspond to a partial region of the first electrode AE exposed by the opening 70-OP.

The light emitting layer EL may be located on the first electrode AE. The light emitting layer EL may be located in the region defined by the opening 70-OP. That is, the light emitting layer EL may be independently formed for each pixel. When the light emitting layer EL is separately formed in each pixel, each of the light emitting layers EL may emit a light of at least one of a blue color, a red color, or a green color. However, embodiments according to the present disclosure are not limited thereto. For example, the light emitting layer EL may be provided to be connected in common with the pixels. In this case, the light emitting layer EL may provide a blue light or may provide a white light.

The second electrode CE may be located on the light emitting layer EL. The second electrode CE may have an integral form and may be included in a plurality of pixels in common.

According to some embodiments, a hole control layer may be interposed between the first electrode AE and the light emitting layer EL. The hole control layer may be located in common in the emission region PXA and the non-emission region NPXA. The hole control layer may include a hole transport layer and may further include a hole injection layer. An electron control layer may be located between the light emitting layer EL and the second electrode CE. The electron control layer may include an electron transport layer and may further include an electron injection layer. The hole control layer and the electron control layer may be formed in the plurality of pixels in common by using an open mask.

The encapsulating layer 140 may be located on the light emitting element layer 130. The encapsulating layer 140 may include an inorganic layer, an organic layer, and an inorganic layer sequentially stacked, and layers constituting the encapsulating layer 140 are not limited thereto. The inorganic layers may protect the light emitting element layer 130 from moisture and oxygen, and the organic layer may protect the light emitting element layer 130 from a foreign substance or contaminants such as dust particles. The inorganic layers may include a silicon nitride layer, a silicon oxynitride layer, a silicon oxide layer, a titanium oxide layer, or an aluminum oxide layer. The organic layer may include an acrylic-based organic layer, but embodiments according to the present disclosure are not limited thereto.

The sensor layer 200 may include a base layer 201, a first conductive layer 202, a sensing insulating layer 203, a second conductive layer 204, and a cover insulating layer 205.

The base layer 201 may be an inorganic layer including at least one of a silicon nitride, a silicon oxynitride, or a silicon oxide. Alternatively, the base layer 201 may be an organic layer including an epoxy resin, an acrylic resin, or an imide-based resin. The base layer 201 may have a single-layer structure or a multi-layer structure including layers stacked in the third direction DR3.

Each of the first conductive layer 202 and the second conductive layer 204 may have a single-layer structure or a multi-layer structure including the layers stacked in the third direction DR3.

A conductive layer in a single-layer structure may include a metal layer or a transparent conductive layer. The metal layer may include molybdenum, silver, titanium, copper, aluminum, or the alloy thereof. The transparent conductive layer may include a transparent conductive oxide such as indium tin oxide (ITO), indium zinc oxide (IZO), zinc oxide (ZnO), or indium zinc tin oxide (IZTO). In addition, the transparent conductive layer may include conductive polymer such as poly(3,4-ethylenedioxythiophene) (PEDOT), metal nanowire, or graphene.

A conductive layer in a multi-layer structure may include metal layers. The metal layers may have, for example, a three-layer structure of titanium/aluminum/titanium. The conductive layer in the multi-layer structure may include at least one metal layer and at least one transparent conductive layer.

At least one of the sensing insulating layer 203 or the cover insulating layer 205 may include an inorganic film. The inorganic film may include at least one of an aluminum oxide, a titanium oxide, a silicon oxide, a silicon nitride, a silicon oxynitride, a zirconium oxide, or a hafnium oxide.

At least one of the sensing insulating layer 203 or the cover insulating layer 205 may include an organic film. The organic film may include at least one of an acrylic resin, a methacrylic resin, a polyisoprene, a vinyl resin, an epoxy resin, a urethane resin, a cellulose resin, a siloxane resin, a polyimide resin, a polyamide resin, or a perylene resin.

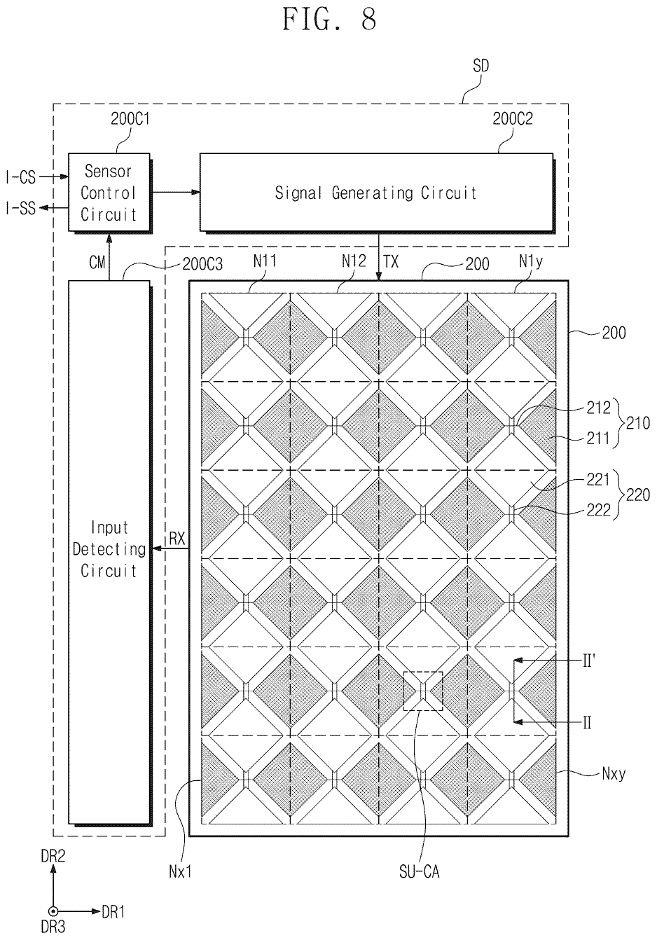

FIG. 7 is a block diagram illustrating the display layer 100 and the display driver 100C according to some embodiments of the present disclosure.

Referring to FIG. 7, the display layer 100 may include a plurality of scan lines SL1 to SLn, a plurality of data lines DL1 to DLm, and a plurality of pixels PX. Although FIG. 7 illustrates a single pixel PX, as a person having ordinary skill in the art would appreciate, the display layer 100 may include any suitable number of pixels PX according to the design and size of the display layer 100. Each of the plurality of pixels PX may be connected to a relevant data line among the plurality of data lines DL1 to DLm, and may be connected to a relevant scan line among the plurality of scan lines SL1 to SLn. According to some embodiments of the present disclosure, the display layer 100 may further include light emitting control lines, and the display driver DD may further include a light emitting driving circuit to provide control signals to the light emitting control lines. A configuration of the display layer 100 is not specifically limited.

Each of the plurality of scan lines SL1 to SLn may extend in the first direction DR1, and the plurality of scan lines SL1 to SLn may be arranged to be spaced from each other in the second direction DR2. Each of the plurality of data lines DL1 to DLm may extend in the second direction DR2, and the plurality of data lines DL1 to DLm may be arranged to be spaced from each other in the first direction DR1.

The display driver DD may include a signal control circuit 100C1, a scan driving circuit 100C2, and a data driving circuit 100C3.

The signal control circuit 100C1 may receive the image data RGB and a control signal D-CS from the processor PR (see FIG. 4). The control signal D-CS may include various signals. For example, the control signal D-CS may include an input vertical synchronization signal, an input horizontal synchronization signal, a main clock, and a data enable signal.

The signal control circuit 100C1 may generate a first control signal CONT1 and a vertical synchronization signal Vsync based on the control signal D-CS and may output the first control signal CONT1 and the vertical synchronization signal Vsync to the scan driving circuit 100C2.

The signal control circuit 100C1 may generate a second control signal CONT2 and a horizontal synchronization signal Hsync based on the control signal D-CS and may output the second control signal CONT2 and the horizontal synchronization signal Hsync to the data driving circuit 100C3.

In addition, the signal control circuit 100C1 may output, to the data driving circuit 100C3, a driving signal DS which is obtained by processing the image data RGB to be appropriate for an operation condition of the display layer 100. The first control signal CONT1 and the second control signal CONT2 are signals necessary for the operations of the scan driving circuit 100C2 and the data driving circuit 100C3, but embodiments according to the present disclosure are not specially limited thereto.

The scan driving circuit 100C2 may drive the plurality of scan lines SL1 to SLn in response to the first control signal CONT1 and the vertical synchronization signal Vsync. According to some embodiments of the present disclosure, the scan driving circuit 100C2 may be formed in the same process as the circuit layer 120 (see FIG. 4) in the display layer 100, but embodiments according to the present disclosure are not limited thereto. For example, the scan driving circuit 100C2 may be implemented in the form of an integrated circuit (IC) and mounted directly in a specific region of the display layer 100, or mounted in the form of a chip on film (COF) manner on a separate printed circuit board, such that the scan driving circuit 100C2 is electrically connected to the display layer 100.

The data driver circuit 100C3 may output grayscale voltages to the plurality of data lines DL1 to DLm in response to the second control signal CONT2, the horizontal synchronization signal Hsync, and the driving signal DS from the signal control circuit 100C1. The data driving circuit 100C3 may be implemented in the form of an integrated circuit to be directly mounted in a specific region of the display layer 100 or be mounted on a separate printed circuit board in a chip on film manner, such that the data driving circuit 100C3 is electrically connected to the display layer 100, but embodiments according to the present disclosure are not limited thereto. For example, the data driving circuit 100C3 may be formed in the same process as the circuit layer 120 (see FIG. 5) in the display layer 100.

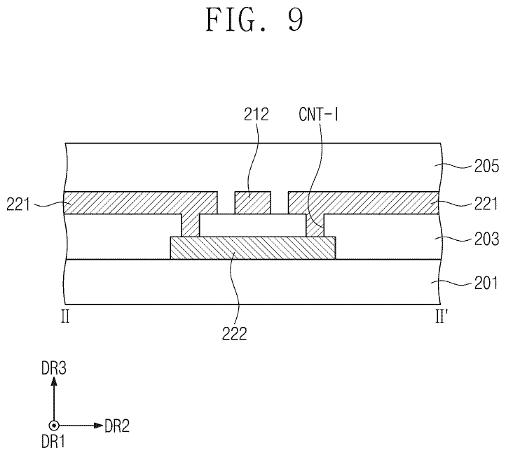

FIG. 8 is a block diagram illustrating a sensor layer and a sensor driver according to some embodiments of the present disclosure.

Referring to FIG. 8, the sensor layer 200 may include a plurality of sensing nodes N11 to Nxy. In this case, ‘x’ is a positive integer and a ‘y’ is a positive integer. The plurality of sensing nodes N11 to Nxy may be arranged in the first direction DR1 and the second direction DR2.

FIG. 8 illustrates four sensing nodes N11, N12, . . . , and N1y arranged in the first direction DR1 and six sensing nodes N11 to Nx1 arranged in the second direction DR2. However, the number of the plurality of sensing nodes N11 to Nx1 is not limited thereto, but may be smaller than or larger than the number of the sensing nodes N11 to Nx1 illustrated in FIG. 8.

Each of the plurality of sensing nodes N11 to Nxy may include a first electrode 210 extending in the first direction DR1 and a second electrode 220 extending in the second direction DR2. The first electrode 210 and the second electrode 220 may be insulated from each other while crossing each other.

The first electrode 210 may include a plurality of first parts 211 extending in the first direction DR1 and a plurality of second part 212 interposed between the plurality of first parts 211 while being spaced apart from each other.

The plurality of first parts 211 and the plurality of second parts 212 may be formed integrally with each other. The plurality of first parts 211 and the plurality of second parts 212 may be located in the same layer. For example, the first parts 211 and the second parts 212 may be included in the second conductive layer 204 (see FIG. 6).

The second electrode 220 may include a bridge pattern 222 extending in the second direction DR2 and a plurality of sensing patterns 221 connected to the bridge pattern 222 and spaced apart from each other in the second direction DR2.

A plurality of bridge patterns 222 may be provided. FIG. 8 illustrates two bridge patterns 222. The two bridge patterns 222 may be insulated from the second part 212 while crossing the second part 222.

The two sensing patterns 221 adjacent to each other may be electrically connected to each other through two bridge patterns 222, but the present disclosure is specifically not limited thereto.

The plurality of sensing patterns 221 may be included in the second conductive layer 204 (see FIG. 6), and the bridge pattern 222 may be included in the first conductive layer 202 (see FIG. 6).

The plurality of sensing patterns 221 and the plurality of bridge patterns 222 may be located in different layers.

The sensor layer 200 may further include a plurality of signal lines connected to the first electrode 210 and the second electrode 220.

The sensor driver SD may drive the sensor layer 200. The sensor driver SD may be driven in a unit of a plurality of sensing frames. The sensor driver SD may sense a coordinate based on a capacitance of each of the plurality of sensing nodes N11 to Nxy, for each of the plurality of sensing frames.

The sensor driver SD may receive a control signal I-CS from the processor PR (see FIG. 4) and may provide the coordinate signal I-SS to the processor PR (see FIG. 4).

The sensor driver SD may be implemented in the form of an integrated circuit (IC) and mounted directly in a specific region of the sensor layer 200, or mounted in the form of a chip on film (COF) manner on a separate printed circuit board, such that the sensor driver SD is electrically connected to the sensor layer 200.

The sensor driver SD may include a sensor control circuit 200C1, a signal generating circuit 200C2, and an input detecting circuit 200C3. The sensor control circuit 200C1 may control operations of the signal generating circuit 200C2, and an input detecting circuit 200C3, based on the control signal I-CS.

The signal generating circuit 200C2 may sequentially output the driving signal TX to the sensor layer 200, for example, the second electrodes 220. The input detecting circuit 200C3 may receive sensing signals RX from the sensor layer 200. For example, the input detecting circuit 200C3 may receive the sensing signals RX from the first electrodes 210. According to some embodiments of the present disclosure, the signal generating circuit 200C2 may sequentially output the driving signal TX to the second electrodes 220, and the input detecting circuit 200C3 may receive the sensing signals RX from the first electrodes 210.

The input detecting circuit 200C3 may convert the sensing signals RX into a plurality of sensitivity values CM. For example, the sensing signals RX may be analog capacitive signals made by a touch. The input detecting circuit 200C3 may include an analog-digital converter to convert the analog capacitive signal into sensitivity values CM in a digital form.

The plurality of sensing signals RX and the plurality of sensitivity values CM corresponding to the sensing signals RX may correspond to the nodes N11 to Nxy, respectively. The plurality of sensitivity values CM may be calculated based on the plurality of nodes N11 to Nxy. The plurality of sensitivity values CM may correspond to the nodes N11 to Nxy, respectively. For example, one sensitivity value may be derived from one sensing signal corresponding to one node. The plurality of sensitivity values CM may correspond to capacitances of the plurality of sensing nodes N11 to Nxy.

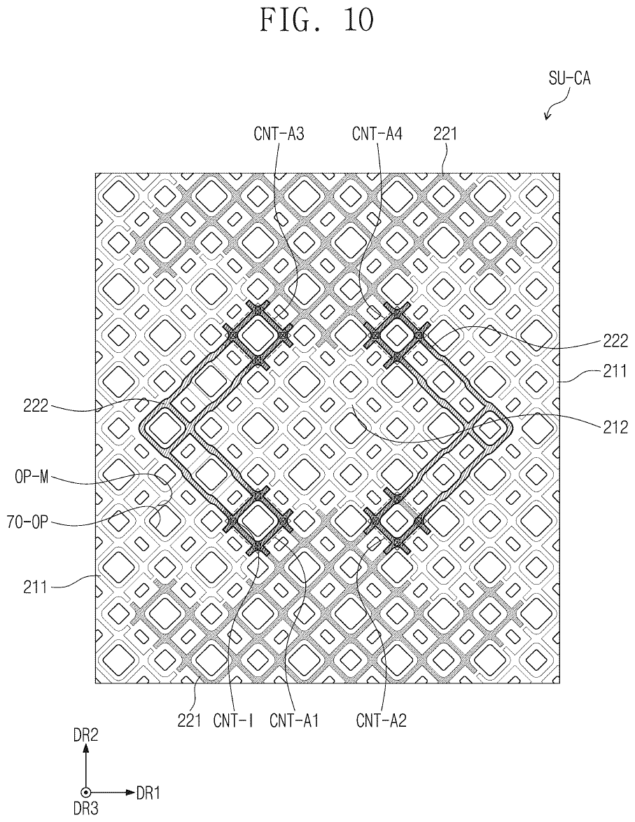

FIG. 9 is a cross-sectional view taken along line II-II′ of FIG. 8 according to some embodiments of the present disclosure.

Referring to FIGS. 8 and 9, the sensor layer 200 may have a bottom bridge structure. For example, the bridge pattern 222 may be included in the first conductive layer 202 (see FIG. 6), and the sensing pattern 221 and the second part 212 may be included in the second conductive layer 204 (see FIG. 6). The sensing pattern 221 may be connected to the bridge pattern 222 through the contact hole CNT-I formed through the sensing insulating layer 203.

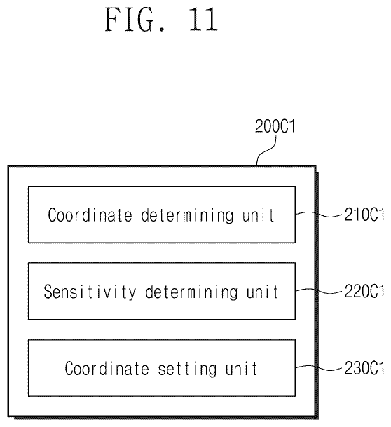

FIG. 10 is an enlarged plan view of a crossing region of FIG. 8 according to some embodiments of the present disclosure.

Referring to FIGS. 8 and 10, a crossing region SU-CA may be a region in which a plurality of bridge patterns 222 are located.

Each of the plurality of sensing patterns 221 may have a mesh structure. An opening OP-M may be defined in each of the sensing patterns 221. One opening OP-M may be overlapped with the opening 70-OP defined in the pixel defining layer 70 (refer to FIG. 6). However, this is provided only for the illustrative purpose, and one opening OP-M may be overlapped with a plurality of openings 70-OP. The plurality of first parts 211 and the plurality of second parts 212 may have a mesh structure similar to the plurality of sensing patterns 221.

The two bridge patterns 222 may connect two sensing patterns 221 to each other. First to fourth connection regions CNT-A1 to CNT-A4 are interposed between the two bridge patterns 222 and the two sensing patterns 221. Four contact holes CNT-I may be formed in the first to fourth connection regions CNT-A1 to CNT-A4, respectively. However, this is provided only for the illustrative purpose, and the two sensing patterns 221 may be electrically connected to each other through one bridge pattern. In addition, according to some embodiments of the present disclosure, the two sensing patterns 221 may be electrically connected to each other through at least three bridge patterns.

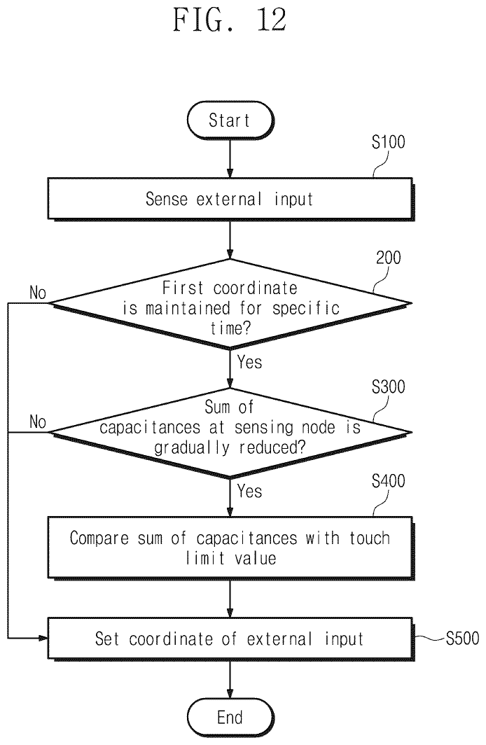

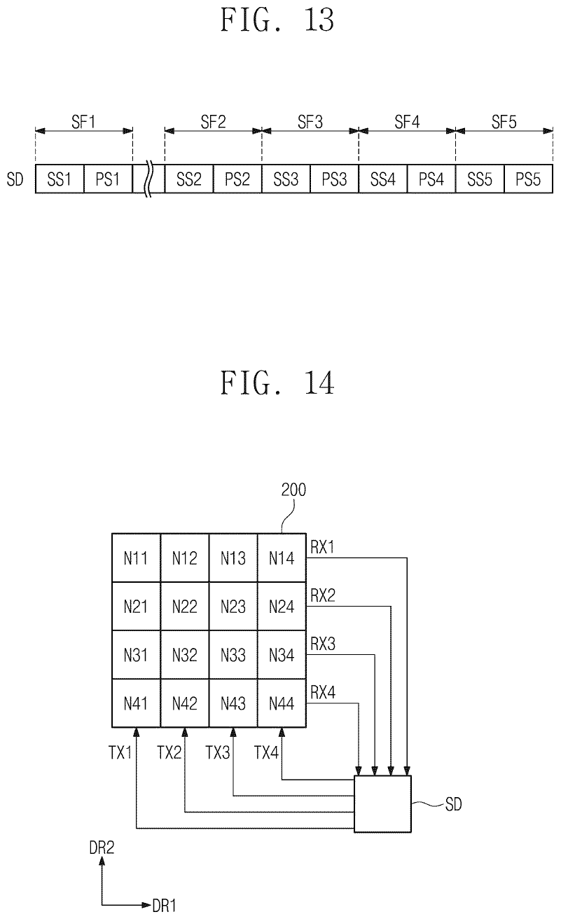

FIG. 11 is a block diagram illustrating a sensor control circuit according to some embodiments of the present disclosure, and FIG. 12 is a flowchart illustrating aspects of a method for driving an electronic device according to some embodiments of the present disclosure. Although FIG. 12 illustrates various operations in a method for driving an electronic device, embodiments according to the present disclosure are not limited thereto, and according to various embodiments, the method may include additional operations, or fewer operations, or the order of operations may vary, without departing from the spirit and scope of embodiments according to the present disclosure.

Referring to FIGS. 8, 11, and 12, the sensor layer 200 may include a plurality of sensing nodes N11 to Nxy. The sensor driver SD may be driven in a unit of a plurality of sensing frames. The sensor driver SD may sense a coordinate based on a capacitance of each of the plurality of sensing nodes N11 to Nxy, for each of the plurality of sensing frames.

The sensor control circuit 200C1 may include a coordinate determining unit (or coordinate determiner, or coordinate determining component, or coordinate determining circuit) 210C1, a sensitivity determining unit (or sensitivity determiner, or sensitivity determining component, or sensitivity determining circuit) 220C1, and a coordinate setting unit (or coordinate setter, or coordinate setting component, or coordinate setting circuit) 230C1.

The sensor driver SD may sense an external input as a first coordinate, based on the capacitance of each of the plurality of sensing nodes N11 to Nxy (S100).

The coordinate determining unit 210C1 may determine whether the first coordinate is maintained for a specific time (S200). The specific time may range 0.5 second to 1.5 seconds. For example, the specific time may be one second.

The coordinate determining unit 210C1 may determine whether the first coordinate are a coordinate desired by a user. The first coordinate may be referred to as a specific coordinate. The coordinate determining unit 210C1 may regard the specific coordinate as the coordinate desired by the user, when a dwell time is equal to or greater than the specific time.

The coordinate determining unit 210C1 may not determine a present operation as an operation for sensing a fine coordinate, when the first coordinate is not maintained for the specific time. In this case, according to some embodiments of the present disclosure, the method for driving the electronic device needs not be applied.

In this case, the coordinate determining unit 210C1 may set a coordinate sensed as a final coordinate (S500).

The sensitivity determining unit 220C1 may determine whether the sum of capacitances at the plurality of sensing nodes N11 to Nxy is gradually reduced for at least two sensing frames of the plurality of sensing frames (S300)

The at least two sensing frames may be processed after the coordinate determining unit 210C1 determines whether the first coordinate is maintained for the specific time.

The sensitivity determining unit 220C1 may determine whether sensitivity is gradually reduced. The sensitivity determining unit 220C1 may determine the sensitivity, based on the sum of the capacitance at the sensing node having the first coordinate sensed and capacitances at one to four sensing nodes around the sensing node having the first coordinate sensed. The sensitivity determining unit 220C1 may determine whether a user hand is moving away from the sensor layer 200.

The sensitivity determining unit 220C1 may not determine a present operation as an operation for sensing a fine coordinate, when the sensitivity is not gradually reduced. In this case, according to some embodiments of the present disclosure, the method for driving the electronic device needs not be applied. In this case, the sensitivity determining unit 220C1 may set a coordinate sensed as a final coordinate (S500).

The coordinate setting unit 230C1 may compare the sum of the capacitances with a touch limit value (S400). The coordinate setting unit 230C1 may set a coordinate (S500).

The coordinate setting unit 230C1 may determine whether the user hand is completely removed from the sensor layer 200. The coordinate setting unit 230C1 may determine that the user hand is completely removed from the sensor layer 200, when the sum of the capacitances is less than the touch limit value or is equal to ‘0’.

The coordinate setting unit 230C1 may set, as the final coordinate, the first coordinate determined in the coordinate determining unit 210C1, when the operations of the coordinate determining unit 210C1 and the sensitivity determining unit 220C1 are satisfied. The coordinate setting unit 230C1 may provide the coordinate signal I-SS including the first coordinate, to the processor PR (see FIG. 4).

In addition, the coordinate setting unit 230C1 may not transmit, to the processor PR (see FIG. 4), a coordinate sensed after the first coordinate are set as the final coordinate.

Unlike the present disclosure, in the process for sensing the fine coordinate, the sensing may be weakly made even during the movement of the user hand away from the sensor layer 200. Accordingly, the sensor driver SD may form coordinate based on the sensing result. In this case, an unintentional coordinate may be output as the final coordinate. However, according to the present disclosure, the sensor driver SD may not output a coordinate, which are erroneously formed as the user hand is removed from the sensor layer 200, as the final coordinate. The sensor driver SD may set the coordinate desired by the user as the final coordinate. Accordingly, the electronic device ED (see FIG. 4) having relatively improved sensing reliability and the method for driving the electronic device ED may be provided.

The processor PR may perform a control operation such as the user selects whether the method for driving the electronic device according to some embodiments of the present disclosure is used.

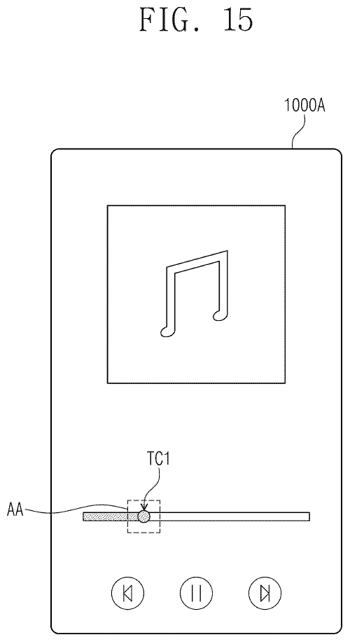

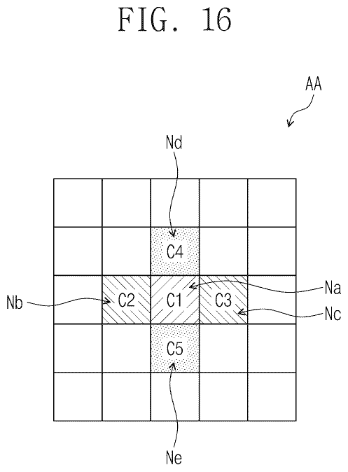

FIG. 13 is a view illustrating the driving of a sensor driver according to some embodiments of the present disclosure, and FIG. 14 is a view illustrating a sensor layer and a sensor driver according to some embodiments of the present disclosure.

Referring to FIGS. 11 to 14, the sensor driver SD may drive the sensor layer 200 in units of a plurality of sensing frames SF1 to SF5 to sense an external input. Each of the plurality of sensing frames SF1 to SF5 may have a driving frequency of 120 Hz. In other words, the sensing frame SF may operate at a period of 8.3 milliseconds (ms). However, this is provided only for the illustrative purpose, and the driving frequencies of the sensing frames SF1 to SF5 according to some embodiments of the present disclosure are not limited thereto.

The sensor layer 200 may include the plurality of sensing nodes N11 to Nxy. FIG. 14 illustrates 16 sensing nodes.

The plurality of sensing frames SF1 to SF5 may include the first sensing frame SF1, the second sensing frame SF2, the third sensing frame SF3, the fourth sensing frame SF4, and the fifth sensing frame SF5.

The first sensing frame SF1 may include a first scan segment SS1 and a first processing segment PS1. The second sensing frame SF2 may include a second scan segment SS2 and a second processing segment PS2. The third sensing frame SF3 may include a third scan segment SS3 and a third processing segment PS3. The fourth sensing frame SF4 may include a fourth scan segment SS4 and a fourth processing segment PS4. The fifth sensing frame SF5 may include a fifth scan segment SS5 and a fifth processing segment PS5.

The sensor driver SD may transmit a plurality of driving signals TX1, TX2, TX3, TX3, and TX4 to the sensor layer 200 for the scan segments SS1, SS2, SS3, SS4 and SS5.

Each of the plurality of driving signals TX1, TX2, TX3, and TX4 may be provided to sensing nodes, which are arranged in the second direction DR2, among the sensing nodes N11 to N44. For example, the plurality of driving signals TX1, TX2, TX3, and TX4 may be provided to the second electrodes 220, respectively.

The plurality of driving signals TX1, TX2, TX3, and TX4 may include the first driving signal TX1, the second driving signal TX2, the third driving signal TX3, and the fourth driving signal TX4.

The first driving signal TX1 may be provided to a plurality of sensing nodes N11, N21, N31, and N41. The second driving signal TX2 may be provided to a plurality of sensing nodes N12, N22, N32, and N42. The third driving signal TX3 may be provided to a plurality of sensing nodes N13, N23, N33, and N43. The fourth driving signal TX4 may be provided to a plurality of sensing nodes N14, N24, N34, and N44.

The first driving signal TX1 to the fourth driving signal TX4 may be sequentially provided.

The sensor driver SD may receive a plurality of sensing signals RX1, RX2, RX3, TX3, and RX4 from the sensor layer 200 for the scan segments SS1, SS2, SS3, and SS5.

When the sensor layer 200 operates in a mutual capacitive manner, each of the plurality of sensing signals RX1, RX2, RX3, and RX4 may be received from sensing nodes, which are arranged in the first direction DR1, among the sensing nodes N11 to N44. For example, the plurality of first electrodes 210 may output the plurality of sensing signals RX1, RX2, RX3, and RX4 corresponding to the plurality of driving signals TX1, TX2, TX3, TX3, and TX4 which are input to the plurality of second electrodes 220.

The plurality of sensing signals RX1, RX2, RX3, and RX4 may include the first sensing signal RX1, the second sensing signal RX2, the third sensing signal RX3, and the fourth sensing signal RX4.

The first sensing signal RX1 may be received from a plurality of sensing nodes N11, N12, N13, and N14. The second sensing signal RX2 may be received from a plurality of sensing nodes N21, N22, N23, and N24. The third sensing signal RX3 may be received from the plurality of sensing nodes N31, N32, N33, and N34. The fourth sensing signal RX4 may be received from the plurality of sensing nodes N41, N42, N43, and N44.

The sensor driver SD may calculate the plurality of sensitivity values CM (see FIG. 8), based on the plurality of sensing signals RX1, RX2, RX3, and RX4 for the processing segments PS1, PS2, PS3, and PS5. The sensor driver SD may calculate the sum of capacitances measured at some sensing nodes selected from among the plurality of sensing nodes N11 to N44, for the processing segments PS1, PS2, PS3, and PS5.

The sensor driver SD may calculate a coordinate, based on the plurality of sensing signals RX1, RX2, RX3, and RX4 for the processing segments PS1, PS2, PS3, and PS5. The coordinate may be expressed through a coordinate system. For example, the coordinate may be expressed as (x, y), including an ‘x’ value corresponding to a first axis extending in the first direction DR1 and a ‘y’ value corresponding to a second axis extending in the second direction DR2.

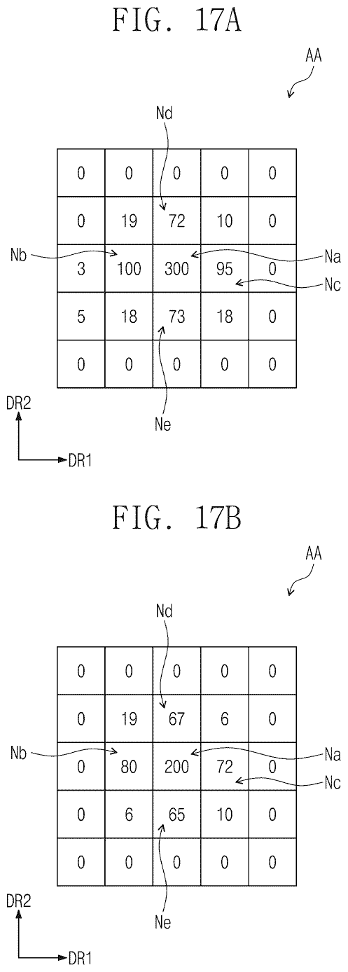

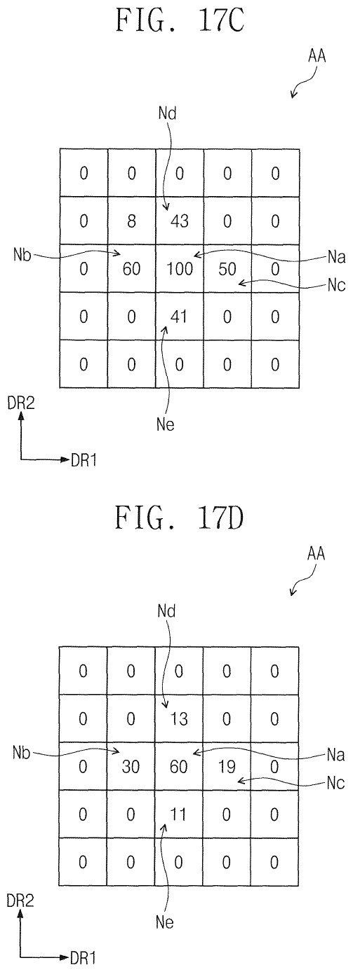

FIG. 15 is a view illustrating an active region of an electronic device according to some embodiments of the present disclosure, and FIG. 16 is a view illustrating sensing nodes in the region AA of FIG. 15 according to some embodiments of the present disclosure.

Referring to FIGS. 8, 15, and 16, an active region 1000A may display an image related to reproducing music.

A user may make a touch TC1 to a reproducing bar, drag the reproducing bar, and then move away from the reproducing bar to reproduce a specific position when reproducing a dynamic image or music.

A plurality of cells illustrated in FIG. 16 may refer to some of the plurality of sensing nodes N11 to Nxy.

The sensor driver SD may sense first coordinate corresponding to the touch TC1. The first coordinate may be calculated based on at least two sensing nodes. For example, the first coordinate may be calculated based on five sensing nodes.

The first coordinate may be calculated based on a first sensing node Na, a second sensing node Nb, a third sensing node Nc, a fourth sensing node Nd, and a fifth sensing node Ne among the plurality of sensing nodes N11 to Nxy.

The first sensing node Na may be a sensing node having the highest capacitance. The first sensing node Na may be referred to as the central node. The first sensing node Na may have a first sensitivity value C1. The first sensitivity value C1 may be a capacitance measured at the first sensing node Na.

The second sensing node Nb and the third sensing node Nc may be spaced apart from each other in the first direction DR1 while interposing the first sensing node Na between the second sensing node Nb and the third sensing node Nc. The second sensing node Nb may have a second sensitivity value C2. The second sensitivity value C2 may be a capacitance measured at the second sensing node Nb. The third sensing node Nc may have a third sensitivity value C3. The third sensitivity value C3 may be a capacitance measured at the third sensing node Nc.

The fourth sensing node Nd and the fifth sensing node Ne may be spaced apart from each other in the second direction DR2 while interposing the first sensing node Na between the fourth sensing node Nd and the fifth sensing node Ne. The fourth sensing node Nd may have a fourth sensitivity value C4. The fourth sensitivity value C4 may be a capacitance measured at the fourth sensing node Nd. The fifth sensing node Ne may have a fifth sensitivity value C5. The fifth sensitivity value C5 may be a capacitance measured at the fifth sensing node Ne.

In other words, when a coordinate is calculated based on five sensing nodes, the coordinate may be calculated by using the central node and four sensing nodes placed left, right, up, and down around the central node.

The first coordinate may be calculated through Center of Mass based on the first sensing node Na, the second sensing node Nb, the third sensing node Nc, the fourth sensing node Nd, and the fifth sensing node Ne.

For example, when the coordinate is calculated through Center of Mass based on the first sensing node Na and the second sensing node Nb, the coordinate may be calculated through following Equation 1.

$$coordinate = ( M 1 * A + M 2 * B ) / ( M 1 + M 2 ) \qquad Equation 1$$

In Equation 1, ‘M1’ may refer to the first sensitivity value C1, ‘M2’ may refer to the second sensitivity value C2, ‘A’ may refer to the position of the first sensing node Na, and ‘B’ may refer to the position of the second sensing node Nb.

For example, when calculating the ‘x’ value of the coordinate, and when the position of the first sensing node Na on the first axis is 30, the position of the second sensing node Nb on the first axis is 40, the first sensitivity value C1 is 50, and the second sensitivity value C2 is 25, the sensing driver SD may calculate the ‘x’ value of the touch TC1 as 33.

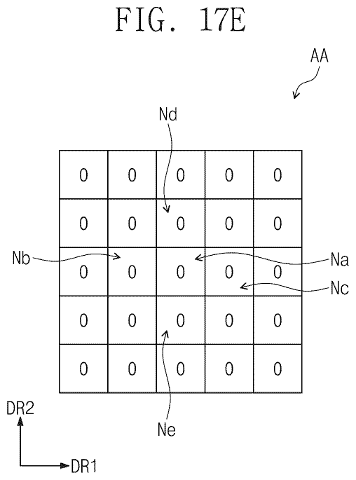

FIG. 17A to 17E are views illustrating sensing nodes and a plurality of sensitivities values in region AA of FIG. 15 according to some embodiments of the present disclosure. In the following description made with reference to FIGS. 17A to 17E, the components that are described with reference to FIG. 16 are assigned with the same reference numerals, and the details thereof will be omitted.

Referring to FIGS. 11 to 17E, in the method for driving the electronic device ED (see FIG. 4), the sensor layer 200 may be driven in a unit of the plurality of sensing frames SF1 to SF5.

The sensor driver SD may sense a coordinate of the touch TC1, based on a capacitance of each of the plurality of sensing nodes N11 to Nxy, for each of the plurality of sensing frames SF1 to SF5.

Following table 1 shows a coordinate calculated based on sensitivity values C1 and C2 measured at the first sensing node Na and the second sensing node Nb, for each sensing frame.

TABLE 1

| | Node 1 | | Node 2 | | |
|---|---|---|---|---|---|
| Frame | Position | Sensitivity | Position | Sensitivity | Coordinate |
| 1 | 30 | 300 | 40 | 100 | 33 |
| 2 | 30 | 250 | 40 | 150 | 34 |
| 3 | 30 | 200 | 40 | 200 | 35 |
| 4 | 30 | 150 | 40 | 250 | 36 |
| 5 | 30 | 100 | 40 | 300 | 38 |
| 6 | 30 | 80 | 40 | 200 | 37 |
| 7 | 30 | 60 | 40 | 100 | 36 |
| 8 | 30 | 30 | 40 | 60 | 36 |
| 9 | 30 | 0 | 40 | 0 | 36 |

In Table 1, some of frames may refer to the plurality of sensing frames SF1 to SF5. ‘Node 1’ may refer to the first sensing node Na. ‘Position’ may refer to each of positions of the sensing nodes Na and Nb. For example, the position of the first sensing node Na may be 30, and the position of the second sensing node Nb may be 40. ‘Sensitivity’ may refer to each of sensitivity values C1 and C2 of the sensing nodes Na and Nb. ‘Coordinate’ may refer to a coordinate. The sensor driver SD may sense, in the form of a coordinate, an external input, based on capacitances of the plurality of sensing nodes Na and Nb, for each of first to fourth frames (S100).

The coordinate determining unit 210C1 may determine whether the first coordinate is maintained for the specific time (S200). The coordinate determining unit 210C1 may set the sensed coordinate as the final coordinate (S500), when the coordinate is not maintained for the specific time. The sensor driver SD may output the coordinate signal I-SS including the coordinate.

FIG. 17A illustrates a sensitivity value of each of sensing nodes Na to Ne measured for the fifth frame according to some embodiments of the present disclosure.

The fifth frame may be the first sensing frame SF1. The sensor driver SD may sense, in the form of first coordinate, an external input for the first sensing frame SF1, based on capacitances of the plurality of sensing nodes Na and Nb (S100). The first coordinate may be calculated through Center of Mass based on the first sensing node Na and the second sensing node Nb. In this case, the first coordinate may be 38.

The coordinate determining unit 210C1 may determine whether the first coordinate is maintained for the specific time (S200).

The specific time may be elapsed between the fifth frame and the sixth frame.

When the first coordinate is maintained for the specific time, the sensitivity determining unit 220C1 may determine whether the sum of the capacitances of the plurality of sensing nodes Na and Nb is gradually reduced, for at least two sensing frames (S300).

The sum of the first sensitivity value C1 and the second sensitivity value C2 may be 400 for the first sensing frame SF1.

FIG. 17B illustrates a sensitivity value of each of sensing nodes Na to Ne measured for the sixth frame according to some embodiments of the present disclosure.

The sixth frame may be the second sensing frame SF2. The second sensing frame SF2 may be processed, after the first sensing frame SF1 and the specific time. The at least two sensing frames may be processed after the coordinate determining unit 210C1 determines whether the first coordinate is maintained for the specific time.

The sensitivity determining unit 220C1 may calculate the sum of capacitances measured at the plurality of sensing nodes Na and Nb. The sum of the first sensitivity value C1 and the second sensitivity value C2 may be 280 for the second sensing frame SF2. In other words, the sum of the capacitances may be reduced for the second sensing frame SF2, when compared to the first sensing frame SF1.

FIG. 17C illustrates a sensitivity value of each of sensing nodes Na to Ne measured for the seventh frame according to some embodiments of the present disclosure.

The seventh frame may be the third sensing frame SF3. The sensitivity determining unit 220C1 may calculate the sum of capacitances measured at the plurality of sensing nodes Na and Nb. The sum of the first sensitivity value C1 and the second sensitivity value C2 may be 160 for the third sensing frame SF3. In other words, the sum of the capacitances may be gradually reduced for the first sensing frame SF1 to the third sensing frame SF3.

FIG. 17D illustrates sensitivity values at sensing nodes Na to Ne measured for an eighth frame according to some embodiments of the present disclosure, and FIG. 17E illustrates sensitivity values at sensing nodes Na to Ne measured for a ninth frame according to some embodiments of the present disclosure.

The eighth frame may be the fourth sensing frame SF4. The sensitivity determining unit 220C1 may calculate the sum of capacitances measured at the plurality of sensing nodes Na and Nb. The sum of the first sensitivity value C1 and the second sensitivity value C2 may be 90 for the fourth sensing frame SF4. In other words, the sum of the capacitances may be gradually reduced for the first sensing frame SF1 to the fourth sensing frame SF4.

The sensor driver SD may determine the situation that the sum of capacitances is gradually reduced, as the procedure that the touch TCI moves away, thereby determining an unintentional touch as being made from a remaining sensitivity. The sensor driver SD may neglect a coordinate sensed for each of at least two sensing frames. For example, the sensor driver SD may neglect the coordinate measured for each of the second sensing frame SF2 to the fourth sensing frame SF4.

The ninth frame may be the fifth sensing frame SF5. As the user hand El (see FIG. 4) is completely removed for the fifth sensing frame SF5, the capacitance may not be measured at the plurality of sensing nodes Na to Ne.

The coordinate setting unit 230C1 may compare the sum of the capacitances with the touch limit value (S400).

For example, the preset touch limit value may be 100. The touch limit value may be a minimum sensitivity value for determining the touch TC1 applied. In other words, when the sum of the capacitances is less than the touch limit value, the sensor driver SD may determine that the user hand El (see FIG. 4) is completely removed, and the coordinate setting unit 230C1 may set the coordinate (S500).

Alternatively, the touch limit value may be ‘0’. When the capacitances are not measured at the plurality of sensing nodes Na to Ne, the sensor driver SD may determine the user hand El (see FIG. 4) as being removed, and the coordinate setting unit 230C1 may set the coordinate (S500).

The coordinate setting unit 230C1 may set the first coordinate measured for the first sensing frame SF1 as the final coordinate of the touch TC1. In other words, the coordinate setting unit 230C1 may output the coordinate signal I-SS including 38 which is the first coordinate.

Although Table 1 shows a coordinate calculated based on two sensing nodes, the method for driving the electronic device according to some embodiments of the present disclosure is not limited thereto. For example, the sensor driver SD may calculate a coordinate based on five sensing nodes Na to Ne.

In addition, as shown in Table 1, although the sum of capacitances is calculated based on two sensing nodes by way of example, the sensitivity determining unit 220C1 may determine whether the sum of capacitances is gradually reduced for at least two sensing frames, based on the sum of capacitances at the five sensing nodes Na to Ne. The sum of capacitances may be the sum of capacitances at the first sensing node Na, the second sensing node Nb, the third sensing node Nc, the fourth sensing node Nd, and the fifth sensing node Ne.

Unlike the present disclosure, an unintentional coordinate may be output due to relatively reduced sensitivity, when a user controls a reproducing bar while a finger of the user moves away from the reproducing bar in reproducing a dynamic image or music. Accordingly, the dynamic image or music may be reproduced at an unintentional position. However, according to the present disclosure, the sensor driver SD may not output a coordinate, which is erroneously formed as the user hand is removed from the sensor layer 200, as the final coordinate. The sensor driver SD may neglect the coordinate erroneously formed. The sensor driver SD may set the coordinate desired by the user as the final coordinate. Accordingly, the electronic device ED (see FIG. 4) having relatively improved sensing reliability and the method for driving the electronic device may be provided.

As described above, the sensor driver may not output a coordinate, which is erroneously formed as the user hand is removed from the sensor layer, as the final coordinate. The sensor driver may set a coordinate desired by the user as the final coordinate. The electronic device may have relatively sensing reliability and the method for driving the same may be provided.

Although aspects of some embodiments of the present disclosure have been described for illustrative purposes, those skilled in the art will appreciate that various modifications, and substitutions are possible, without departing from the scope and spirit of the present disclosure as disclosed in the accompanying.

Accordingly, the technical scope of embodiments according to the present disclosure is not limited to the detailed description of this specification, but should be defined by the claims, and their equivalents.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present invention.

While aspects of some embodiments of the present disclosure have been described with reference to embodiments thereof, it will be apparent to those of ordinary skill in the art that various changes and modifications may be made thereto without departing from the spirit and scope of the present disclosure as set forth in the following claims, and their equivalents.

What is claimed is:

1. An electronic device comprising:
a sensor layer configured to sense an external input and including a plurality of sensing nodes; and
a sensor driver configured to drive the sensor layer in a unit of a plurality of sensing frames, and to sense a coordinate, based on a capacitance measured at each of the plurality of sensing nodes, for each of the plurality of sensing frames,
wherein the sensor driver includes:
a coordinate determining unit configured to determine a first coordinate is maintained for a specific time;
a sensitivity determining unit configured to determine a sum of the capacitances measured at the plurality of sensing nodes is gradually reduced, for at least two sensing frames of the plurality of sensing frames; and
a coordinate setting unit configured to set the coordinate by comparing the sum of the capacitances with a touch limit value.

2. The electronic device of claim 1, wherein the first coordinate is calculated through Center of Mass, based on a first sensing node, which has the highest capacitance, of the plurality of sensing nodes, second sensing nodes spaced apart from each other in a first direction while interposing the first sensing node between the second sensing nodes, and third sensing nodes spaced apart from each other in a second direction crossing the first direction, while interposing the first sensing node between the third sensing nodes.

3. The electronic device of claim 2, wherein the sum of the capacitances is a sum of capacitances which are measured at the first sensing node, the second sensing nodes, and the third sensing nodes, respectively.

4. The electronic device of claim 2, wherein each of the plurality of sensing nodes includes:
a first electrode extending in the first direction; and
a second electrode extending in the second direction.

5. The electronic device of claim 4, wherein the first electrode includes a plurality of first parts extending in the first direction and a plurality of second parts spaced apart from each other while interposing the plurality of first parts between the second parts, and
wherein the plurality of first parts and the plurality of second parts are in a same layer.

6. The electronic device of claim 5, wherein the second electrode includes:
a bridge pattern extending in the second direction; and
a plurality of sensing patterns connected to the bridge pattern and spaced apart from each other in the second direction, and
wherein the plurality of sensing patterns and the bridge pattern are in different layers.

7. The electronic device of claim 1, wherein the coordinate setting unit is configured to determine the external input as being removed, based on the sum of the capacitances being less than the touch limit value.

8. The electronic device of claim 7, wherein the coordinate setting unit is configured to set the first coordinate as the coordinate, based on the sensitivity determining unit determining the sum of the capacitances as being gradually reduced, and based on the coordinate setting unit determining the external input as being removed.

9. The electronic device of claim 1, wherein the sensor driver is configured to neglect a coordinate sensed for each of the at least two sensing frames.

10. The electronic device of claim 1, wherein the at least two sensing frames are processed after the coordinate determining unit determines the first coordinate is maintained for the specific time.

11. The electronic device of claim 1, wherein the specific time is one second.

12. The electronic device of claim 1, wherein the touch limit value is ‘0’.

13. A method for driving an electronic device which includes a sensor layer sensing an external input and including a plurality of sensing nodes, and a sensor driver driving the sensor layer in a unit of a plurality of sensing frames, and sensing a coordinate, based on a capacitance measured at each of the plurality of sensing nodes, for each of the plurality of sensing frames, the method comprising:
determining a first coordinate is maintained for a specific time;
determining a sum of the capacitances measured at the plurality of sensing nodes is gradually reduced, for at least two sensing frames of the plurality of sensing frames; and
setting the coordinate by comparing the sum of the capacitances with a touch limit value.

14. The method of claim 13, further comprising:
calculating the first coordinate through Center of Mass, based on a first sensing node, which has the highest capacitance, of the plurality of sensing nodes, second sensing nodes spaced apart from each other in a first direction while interposing the first sensing node between the second sensing nodes, and third sensing nodes spaced apart from each other in a second direction crossing the first direction, while interposing the first sensing node between the third sensing nodes.

15. The method of claim 14, wherein the sum of the capacitances is a sum of capacitances which are measured at the first sensing node, the second sensing nodes, and the third sensing nodes, respectively.

16. The method of claim 13, wherein the setting of the coordinate includes:
determining the external input as being removed, based on the sum of the capacitances being less than the touch limit value.

17. The method of claim 16, wherein the setting of the coordinate includes:
setting the first coordinate as the coordinate based on the sum of the capacitances being determined as being gradually reduced, and based on the external input being determined as being removed.

18. The method of claim 13, wherein the setting of the coordinate includes:
neglecting a coordinate sensed for each of the at least two sensing frames.

19. The method of claim 13, wherein the determining of the sum of the capacitances as being gradually reduced is performed after determining the first coordinate is maintained for the specific time.

20. The method of claim 13, wherein the specific time is one second.
